(19) United States
(12) Patent Application Publication
(10) Pub. No.: US 2003/0070519 A1
(43) Pub. Date: Apr. 17, 2003

(54) Microtome/surgical blade edge, safety shield

(76) Inventor: James Edward Beld, Brandenburg, KY (US)

Correspondence Address: James E. Beld, 3395 Old Mill Rd., Brandenburg, KY, 40108, US

(21) Appl. No.: 09/976,893

(22) Filed: Oct. 15, 2001

(51) Int. Cl. B26D 5/00

(52) U.S. Cl. 83/397; 83/915.5

(57) ABSTRACT

This “personnell Protective Safety Device” is placed over all these types of ultra sharp blade edges to prevent serious cuts and dismemberments to all employees: making, shipping, using, and handling these sharp instruments. These shields are applicable to: Medical, Dental, and industrial use(s). There has been no specific previous type device patented. This device is of the type required and needed to comply with the currently enacted, Federal Regulations, as per the 106th U.S. Congress, O.S.H.A., and the revised POstal Standards. This device as submitted for patent meets those requirements, and may prevent countless serious injuries to all workers, nationally, as well as internationally. I attest to this statement, to be true to my best knowledge of it's content, and context.

### BACKGROUND, SUMMARY, DESCRIPTION OF THE INVENTION

These medical devices form a vinyl protective safety sheath over these extremely sharp, dangerous exposed, knife edged instruments used for cutting ultra thin tissue sections (2 microns, 1/.025″ mounted in parafin, frozen, or gross tissue sections. Doctors, Pathologist, and other technical professionals are constantly exposed to these edges: before, during, and after the performance of their jobs. These devices are described as flexable, disposable, clear vinyl plastic sheaths (polyethylene). Each is made by “blow molding” or hermaticly sealed edges, which are opened/reopened, using adhesive, on one side, which fits over the entire edge surface of the blades. The sheaths are custom made as to size requirements, and retrofitted to: old type, presently used, and all future types of these blades. The blade's edge when covered prevent: sharps, percutaneous injury, and exposure to infectious disease(s). The sheaths are adaptable to any size edges used on all makes/models of Surgical Microtome Instrument in use in Pathology techniques today, or future modeled instruments. This is precisely what the New OSHA Regulations requires. Presently, there are no protective safety devices used on these sharp edged blades or instruments, this dangerous condition has existed for over 40-50 years. The shield/sheaths are meant to be applied at the time the blade is initially placed in service, during, and until the old blades' final disposal. These blades are not now covered at any time, and account for many serious injuries, with professionals.

The protective shields are “primary personnell protective devices” of the types which are now required by Federal Congressional Law, HR5178, revised “Neddlestick, Sharps, prevention Act, enacted April 2001. There were 600,000-800,000 sharps,cuts, injuries in 2000, as reported by CDC, Communicable Disease Center, Atlanta, Ga. My invention, which I pray you grant, will help retify and prevent, this dangerous worksite injury an/or dismemberment to all personnell who must use these type blades and instuments daily.

### DRAWINGS/VIEWS SPECIFICATIONS

Verbal Description: All these clear, disposable, polyethylene plastic, safety shields may be used by all microtome and surgical blades in use today. Each may be retrofitted and used in conjunction with all Microtomes, Cryostats, makes and models, both old and new, from table top to floor models (large).

FIGS. 1 and 2 depicts safety shield intended for application, and use on permanent, non-disable, recycled, resharpened blades. The shields are perforated in sections along the surface, so that the entire blade surface stays covered at all times, The frontal portion of the shield sections are adhesively closed, to facilatate opening and closing as each section of the shield is used, along the blade's edge. The shield is clear, polyethylene plastic, disposable in nature. The shield itself is made of flat, small thickness, thin gaged, stamped, and cut from larger flat plastic sheets. Deminsions as to length and width, vary as to which blade: type, model, and size of surgical blade in use, or intended use. The shield is opened at it's rear surface, across the complete length of the shield, to allow the placement of the plastic shield over the frontal and middle areas of protected blade(s).

FIGS. 3 and 4 are identical in composition and design, and function. These shields are retrofitted over a disposable, thinner blade, lighter in weight, but comparable in sharpness/danger, and ability to injure or dismember fingers. FIG. 4 depicts how the blades are made, shipped, and ejected as needed, from a container. The shields are assembled over the disposable blades as they are made, and allow protection from creation to final disposition after use. FIG. 3 depicts a model as to how the actual blade is mounted onto all microtome/cryostat instruments using a universal mounting blocks

### ADDITIONAL DETAILED DISCRIPTION OF THE INVENTION

This clear, thin gaged (greater than 4 mils), flat, polyethylene, semirigid plastic safety shield is a “personnell protective devise, is produced, stored, and meant to be used with all surgical edged cuting, microtome knives, as well as other sharp edged Medical, Dental, industrial machines and instruments used in conjunction with these potentially dangerous items, where workers are exposed to their edges. This shields are also suggested for use with all unprotected ultra sharp edged utensils such as, but not limited to: scissors, scapels, probes, slave microtomes (industrial). The shields are required to comply with current Federal Laws HR5178, enacted by the 106th U.S. Congress, April 2001, as named the “Needle Stick, Sharps, Prevention Act”. This invention allows all personnell covered by the above regulations to comply with these laws and the more strict Postal Regulations, as mandated. The device allows everyone, a cost-efficent method to prevent many serious personal injuries, by placing the shields on all sharp edged parts at the time of their manufacture, until the final handling and disposal of that sharp edged instrument. The invention also protects over 133,000 health-care workers in the Medical field alone daily, not considering all those Dental, Industrial Workers, now using these dangerous machines. The economical impact of these injuries is unimaginable, as compared to prevention of them by using these protective safety shields”, which are expected to cost less than 1¢per unit, to implement and apply over the sharp edges.

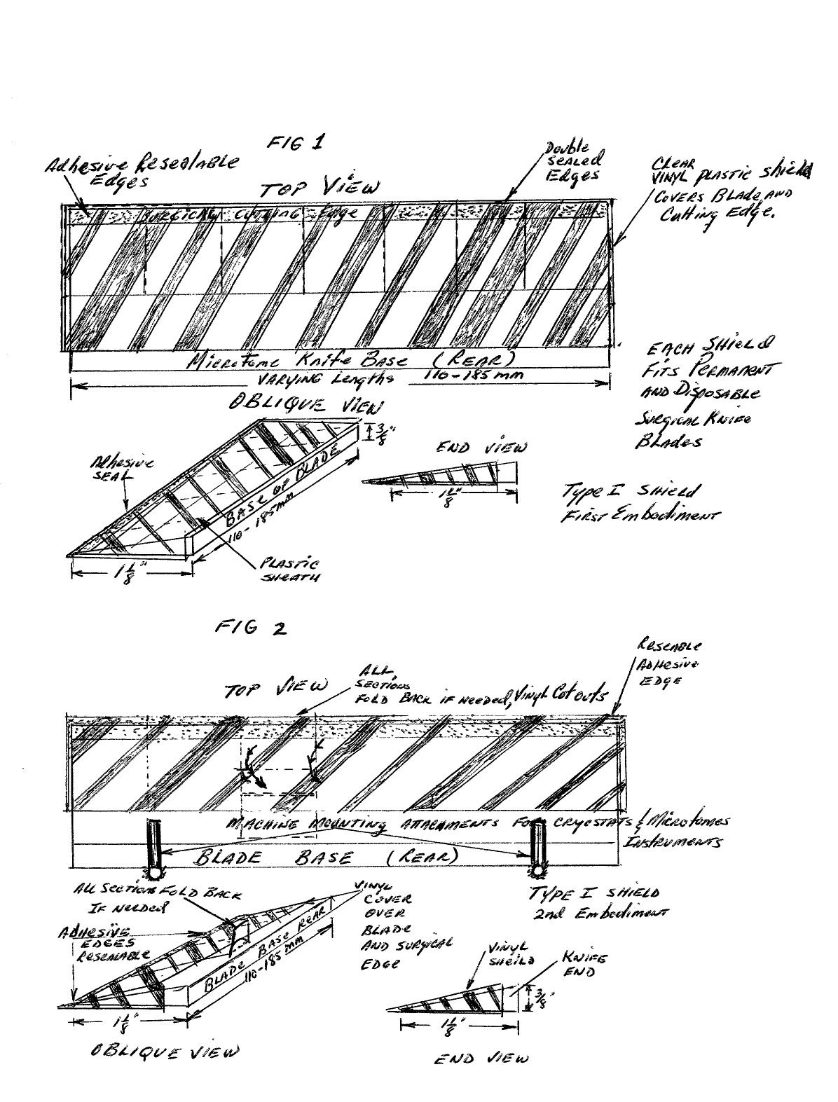

1. What I claim as my invention is a vinyl plastic, protective, safety shield/sheath, made so as to be placed over all sharp edges of all microtome/surgical blades, views—“FIG. 1”, FIG. 2.

2. What I claim, referring to the previous (1) is the same safety device as made for permanent/recyclable type blades depicted in the views for “FIG. 1, FIG. 2.

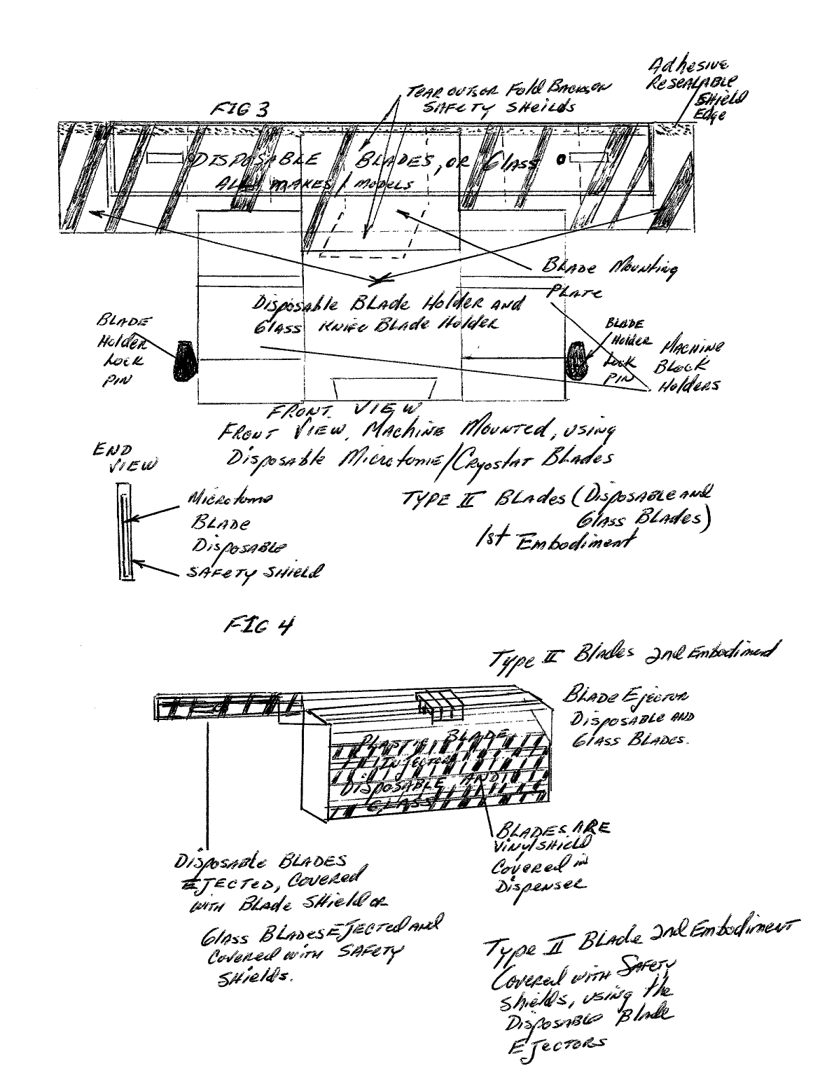

3. What I claim, referred to claim #1, is the same device made to be used as depicted in views, “FIG. 3, FIG. 4” respectively.

4. What I claim as my invention are shields, made to cover other sharp edged instruments such as: scissors, probes, scapels, sensors.
